(19) United States
(12) Patent Application Publication
(10) Pub. No.: US 2015/0110071 A1
(43) Pub. Date: Apr. 23, 2015

(54) APPARATUS AND METHOD FOR HANDOVER IN WIRELESS COMMUNICATION SYSTEM

(71) Applicant: Samsung Electronics Co., Ltd., Suwon-si (KR)

(72) Inventors: Ohyun JO, Seoul (KR); Eun-Young SEO, Suwon-si (KR)

(21) Appl. No.: 14/519,774

(22) Filed: Oct. 21, 2014

(30) Foreign Application Priority Data
Oct. 22, 2013 (KR) 10-2013-0125868

(51) Int. Cl. H04W 36/00

(52) U.S. Cl. CPC H04W 36/0072
USPC 370/331

(57) ABSTRACT

A method of operating a terminal is provided. The method includes receiving resource allocation information for reporting a resource allocated by a target Access Point (AP) before accessing the target AP for a handover, and transmitting a signal for a registration to the target AP through a resource indicated by the resource allocation information.

### CROSS-REFERENCE TO RELATED APPLICATION(S)

This application claims the benefit under 35 U.S.C. §119(a) of a Korean patent application filed on Oct. 22, 2013 in the Korean Intellectual Property Office and assigned Serial number 10-2013-0125868, the entire disclosure of which is hereby incorporated by reference.

### TECHNICAL FIELD

The present disclosure relates to a handover in a wireless communication system.

### BACKGROUND

In a wireless communication system, a registered base station or Access Point (AP) may need to be changed to maintain a seamless service even if a user moves. In general, the changing of the registered base station or AP is defined as a handover or a handoff.

The handover may be classified into a hard handover and a soft handover. In the hard handover, when the user changes the base station or AP which provides a service, the service cannot be received simultaneously from two or more base stations. The user receives a service from a new base station after completely ending a connection with the base station or AP which previously provides the service. In the soft handover, when the user changes the base station or AP from which the service is received, the service can be provided simultaneously from two or more base stations momentarily. Accordingly, it is relatively easy to guarantee a continuity of the service.

In a wireless Local Area Network (LAN) system, a handoff between APs is achieved with the hard handover by default, and a continuity of a user's service is not guaranteed due to a very slow speed. A Code Division Multiple Access (CDMA) system supports the soft handover, whereas the wireless LAN system does not support the soft handover in general according to a standard.

An example in which the hard handoff is achieved in the wireless LAN system is as follows. When a user moves or an obstacle occurs, a link performance between a terminal and an AP gradually deteriorates. When the deterioration of the link performance continues so that the existing AP cannot provide a service any more, the connection is disconnected, and the terminal searches for a new AP. If the new AP is found, the terminal may be registered to the new AP through a registration procedure such as authentication or association, and may receive a service from the new AP. When only the hard handover is supported similarly to the wireless LAN system, a handover problem between APs, which occurs when the user moves, may lead to a significant deterioration in performance felt by the user. However, since the soft handover is not supported, there is a limitation in a performance improvement.

In addition, in case of the wireless LAN system, a medium access is achieved in a contention-based manner. The user contends with other users to access the new AP according to a scheme such as Carrier Sense Multiple Access (CSMA). In this case, if the number of users increases, a time for accessing a radio channel increases exponentially. A probability of a collision with other users is increased in proportion to the number of users, and when the collision occurs, a time delay for accessing the radio channel may occur.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for performing an effective handover in a wireless communication system.

Another aspect of the present disclosure is to provide an apparatus and method for decreasing a time consumed for connecting to a new base station or Access Point (AP) when a handover is performed in a wireless communication system.

Another aspect of the present disclosure is to provide an apparatus and method for decreasing a time consumed for a registration procedure with respect to a new base station or AP when a handover is performed in a wireless communication system.

Another aspect of the present disclosure is to provide an apparatus and method for decreasing a time consumed due to a contention-based access when a handover is performed in a wireless communication system.

Another aspect of the present disclosure is to provide an apparatus and method for performing a handover procedure through a resource dedicated in a wireless communication system.

In accordance with an aspect of the present disclosure, a method of operating a terminal in a wireless communication system is provided. The method includes receiving resource allocation information for reporting a resource allocated by a target AP before accessing the target AP for a handover, and transmitting a signal for a registration to the target AP through a resource indicated by the resource allocation information.

In accordance with another aspect of the present disclosure, a method of operating an AP in a wireless communication system is provided. The method includes transmitting information on at least one neighboring AP to a terminal for performing a handover, and transmitting, to a target AP with which the terminal performs the handover, information required to allocate a resource to the terminal before the terminal accesses the target AP.

In accordance with another aspect of the present disclosure, a method of operating an AP in a wireless communication system is provided. The method includes transmitting resource allocation information for reporting a resource allocated to a terminal which is accessing a different AP, and receiving a signal for a registration from the terminal through a resource indicated by the resource allocation information.

In accordance with another aspect of the present disclosure, a terminal apparatus in a wireless communication system is provided. The terminal apparatus includes a receiver configured to receive resource allocation information for reporting a resource allocated by a target AP before accessing the target AP for a handover, and a transmitter configured to transmit a signal for a registration to the target AP through a resource indicated by the resource allocation information.

In accordance with another aspect of the present disclosure, an AP apparatus in a wireless communication system is provided. The AP apparatus includes a transmitter configured to transmit information on at least one neighboring AP to a terminal for performing a handover, and a backhaul communication unit configured to transmit, to a target AP, for which the terminal performs the handover, information required to allocate a resource to the terminal before the terminal accesses the target AP.

In accordance with another aspect of the present disclosure, an AP apparatus in a wireless communication system is provided. The AP apparatus includes a transmitter configured to transmit resource allocation information for reporting a resource allocated to a terminal which has an access to a different AP, and a receiver configured to receive a signal for a registration from the terminal through a resource indicated by the resource allocation information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example of deploying an Access Point (AP) in a wireless communication system according to an embodiment of the present disclosure;

FIG. 2 illustrates a frame structure for communication in a wireless communication system according to an embodiment of the present disclosure;

FIG. 3 illustrates a handover procedure in a wireless communication system according to an embodiment of the present disclosure;

FIG. 4 illustrates a signal exchange for a handover in a wireless communication system according to an embodiment of the present disclosure;

FIGS. 5A and 5B illustrate examples of a message for a resource allocation in a wireless communication system according to an embodiment of the present disclosure;

FIG. 6 illustrates a procedure of operating a serving AP in a wireless communication system according to an embodiment of the present disclosure;

FIG. 7 illustrates a procedure of operating a terminal in a wireless communication system according to an embodiment of the present disclosure;

FIG. 8 illustrates a procedure of operating a target AP in a wireless communication system according to an embodiment of the present disclosure;

FIG. 9 illustrates a handover procedure in a wireless communication system according to an embodiment of the present disclosure;

FIG. 10 illustrates a signal exchange for a handover in a wireless communication system according to an embodiment of the present disclosure;

FIGS. 11A and 11B illustrate examples of a message for a resource allocation in a wireless communication system according to an embodiment of the present disclosure;

FIG. 12 illustrates a procedure of operating a serving AP in a wireless communication system according to an embodiment of the present disclosure;

FIG. 13 illustrates a procedure of operating a terminal in a wireless communication system according to an embodiment of the present disclosure;

FIG. 14 illustrates a procedure of operating a target AP in a wireless communication system according to an embodiment of the present disclosure;

FIG. 15 illustrates a procedure of operating a terminal in a wireless communication system according to an embodiment of the present disclosure;

FIG. 16 illustrates a procedure of operating a serving AP in a wireless communication system according to an embodiment of the present disclosure;

FIG. 17 illustrates a procedure of operating a target AP in a wireless communication system according to an embodiment of the present disclosure;

FIG. 18 illustrates a procedure of operating a serving AP in a wireless communication system according to an embodiment of the present disclosure;

FIG. 19 is a block diagram of a terminal in a wireless communication system according to an embodiment of the present disclosure; and

FIG. 20 is a block diagram of an AP in a wireless communication system according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure described hereinafter relates to a technique for performing a handover in a wireless communication system.

Terms used hereinafter to refer to information for identifying a channel and a network entity are selected for convenience of explanations. Therefore, the disclosure is not limited to the terms described hereinafter, and other terms may also be used to refer to objects having the same technical meaning. For example, for convenience of explanation, the present disclosure uses terms and names defined in the Institute of Electrical and Electronics Engineers (IEEE) 802.11 standard. However, the present disclosure is not limited to the terms and names, but is equally applicable to a system conforming to another standard.

A handover according to an embodiment of the present disclosure is performed through an operation of acquiring information of a neighboring Access Point (AP), an operation of scanning accessible APs, and an operation of registering to a selected AP.

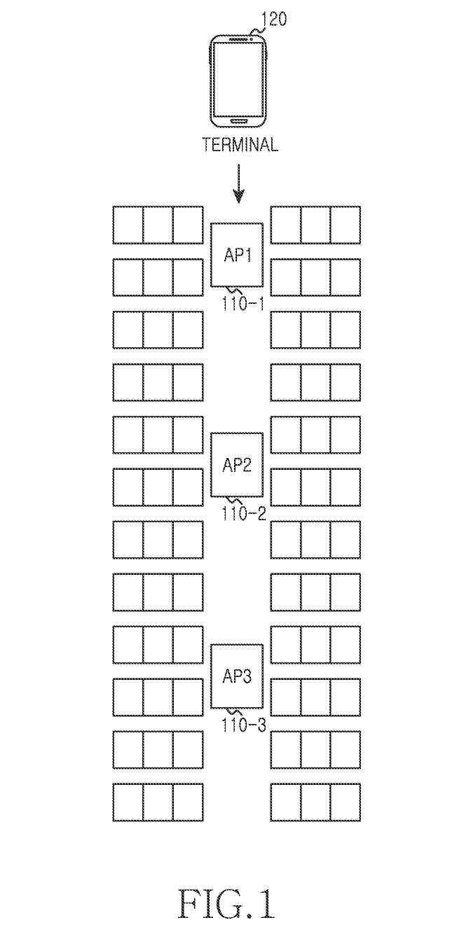

When installed and managed by the same manager similarly to an In-Flight Entertainment (IFE) system or an enterprise network in an office, a more effective handover may be possible. For example, an environment as shown in FIG. 1 may be considered.

FIG. 1 illustrates an example of deploying an Access Point (AP) in a wireless communication system according to an embodiment of the present disclosure.

Referring to FIG. 1, an AP1 110-1, an AP2 110-2, and an AP3 110-3 are installed with a specific interval in an airplane. When a terminal 120 moves along a path, a handover may be performed among the APs 110-1, 110-2, and 110-3.

The terminal which is communicating with the AP feeds back a Received Channel Power Indicator (RCPI). The AP monitors the RCPI, and if a value of the RCPI becomes less than or equal to a specific level, the AP starts a handover procedure of the terminal. In this case, if APs are managed by the same manager as shown in FIG. 1, the AP may report information of a neighboring AP so that the terminal can effectively perform a handoff. A user receives the information of the neighboring AP, and searches for an optimal AP to receive a service by scanning only a channel used in the neighboring AP, instead of scanning all possible channels by using the information of the neighboring AP. Accordingly, a time consumed in an AP scanning procedure can be decreased.

Various embodiments of the present disclosure not only provide neighboring AP information for the AP scanning procedure but also propose a method capable of decreasing a delay time consumed in a contention for a medium access according to the related art.

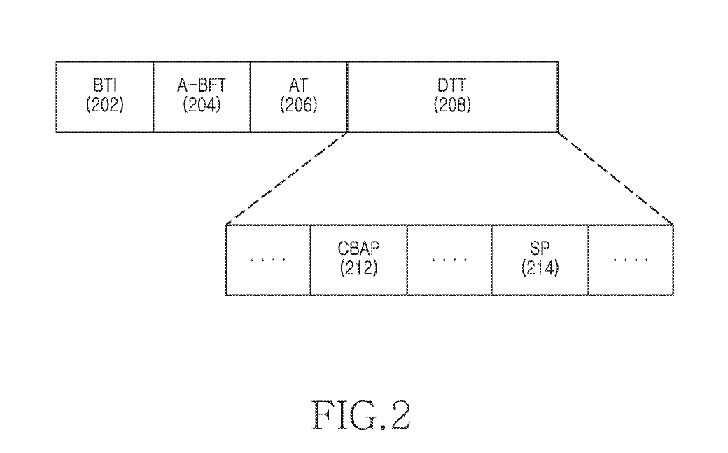

FIG. 2 illustrates a frame structure for communication in a wireless communication system according to an embodiment of the present disclosure. A frame of FIG. 2 may be referred to as a Beacon Interval (BI).

Referring to FIG. 2, the frame includes a Beacon Time Interval (BTI) 202, an Association BeamForming Training (A-BFT) 204, an Announcement Time Interval (ATI) 206, and a Data Transfer Time (DTT) 208.

The BTI 202 is a duration in which at least one mm-Wave beacon is transmitted by an AP. The A-BFT 204 is a duration in which beamforming training is performed between a terminal and the AP. The ATI 206 is a request-response based management duration, and is a duration in which the AP delivers a non-Media Access Control Service Data Unit (MSDU) to the terminal and provides an access opportunity. The DTT 208 is a duration in which a frame is exchanged between devices, and may include at least one Contention-Based Access Period (CBAP) 212 or at least one Service Period (SP) 214. The CBAP 212 is occupied based on a contention between terminals, whereas the SP 214 is a dedicated allocation to the terminal by an allocation of the AP.

In the wireless communication system according to an embodiment of the present disclosure, the terminal may perform a registration procedure by using a duration that can be dedicated to a specific terminal, such as the SP 214 as shown in the frame structure of FIG. 2. By excluding a contention procedure for occupying a resource for delivering a signal transmitted/received for the registration procedure, the time consumed in a handover may be decreased. For this, according to various embodiments of the present disclosure, the terminal and the AP may perform at least one of procedures described below.

A procedure in which a serving AP reports information of a terminal for performing a handover to a target AP may be performed.

When the handover of the terminal is determined, the serving AP provides the terminal with information on the target AP for which a handover is performed, and provides information of the terminal to the target AP. This is to allow the target AP to recognize in advance an existence of the terminal to be newly accessed through the handover and to perform a necessary preparation task.

According to an embodiment of the present disclosure, the terminal may be identified through a variety of information. According to an embodiment of the present disclosure, the terminal may be identified through a Media Access Control (MAC) address. Since the MAC address is a unique number assigned to the terminal, if the target AP is provided with the MAC address of the terminal in advance from the serving AP, the target AP may identify the terminal in advance, and may allocate in advance a resource (e.g., SP) for performing a handover procedure.

A procedure in which the serving AP and the target AP determine a Timing Synchronization Function (TSF) may be performed.

When the handover of the terminal is determined, the terminal must disconnect a connection with the serving AP, and must be registered to the target AP. The most basic requirement for this is a synchronization with the target AP. The terminal receives a beacon frame of the target AP and synchronizes with the target AP. The synchronization implies an operation of confirming TSF information included in the beacon frame of the target AP and matching a TSF managed by the terminal with a TSF of the target AP.

To match the TSF, the terminal receives the beacon of the target AP. However, since a cycle of the beacon may be long, when the terminal listens for the reception of the beacon, a time consumed to perform a handover may increase significantly. Therefore, the serving AP acquires a TSF value of the target AP through a pre-procedure. For example, the serving AP may transmit to the target AP a request message for requesting TSF information, and the target AP may provide its TSF information to the serving AP. Accordingly, the serving AP may determine an offset between its TSF value and a TSF value of the target AP.

A procedure in which the terminal synchronizes with the target AP may be performed based on a TSF offset provided by the serving AP.

As described above, for a synchronization with the target AP when the handover is performed, the terminal receives a beacon frame of the target AP. To decrease a synchronization delay time caused by the reception of the beacon frame, the terminal may acquire information on a TSF value of the target AP from the serving AP. Although the serving AP may provide the TSF value of the target AP, the TSF value of the target AP may change during a time of providing the TSF value to the terminal by the serving AP. In this case, the TSF value provided by the serving AP may be inaccurate information.

Therefore, the serving AP provides the terminal with the TSF offset which is a difference between the TSF value of the target AP and the TSF value of the serving AP. Since the TSF of the target AP and the TSF of the serving AP are increased uniformly, the TSF offset is always a constant value. The terminal has already synchronized with the serving AP and thus presumably manages the same TSF value with the serving AP. Therefore, the terminal can know the TSF value of the target AP by using only the TSF offset. Before performing a handover, the terminal may synchronize in advance with the target AP.

A procedure in which an SP is allocated in advance to the terminal from the target AP may be performed.

When the terminal performs the handover, the target AP may allocate the SP in advance. Through a procedure of allocating the SP in advance, the terminal may significantly decrease a time delay which occurs in a handover process. According to the related art, the terminal which performs the handover must use a resource through a contention with the aforementioned other terminals registered to an AP. As a result, a time delay occurs, which is a main cause of increasing the time taken for a handover. However, according to an embodiment of the present disclosure, the delay time may be decreased when a resource is allocated in advance to the terminal by using a duration that can be dedicated to the terminal.

For example, an AP according to an embodiment of the present disclosure allocates a resource in advance to the terminal which performs a handover by using an SP access scheme specified in the IEEE 802.11ad standard, thereby being able to decrease a time consumed for a registration. According to the IEEE 802.11ad standard, the SP access scheme can be supported when the AP knows information on a service of the terminal after completing a registration procedure between the AP and the terminal. Therefore, the SP cannot be allocated during the handover procedure according to the current IEEE 802.11ad standard. This is because the terminal cannot know information on the target AP, and the target AP cannot know information on the terminal and information on the service.

However, according to an embodiment of the present disclosure, the terminal which performs the handover allocates the SP before being mutually recognized with the target AP, and may perform the SP access without a contention with other terminals by using the SP. After the handover of the terminal is determined, the serving AP reports in advance to the target AP that the terminal will perform the handover to the target AP. Accordingly, the target AP may know in advance that the terminal will perform the handover to the target AP before attempting the registration procedure on the target AP. The target AP may allocate an SP to the terminal which is not yet registered, by using information provided from the serving AP.

In order for the target AP to allocate the SP to a terminal which does not yet acquire sufficient information, a frame for providing allocation information may be used. As information for indicating the terminal in the frame, a MAC address of the terminal or additional identification information defined for the handover may be used.

A procedure in which the terminal matches in advance a beam direction with the target AP may be performed.

When the terminal performs the handover, a beam between the terminal and the target AP must be matched with an optimal path by performing a beamforming protocol immediately after discovering the target AP. According to an embodiment of the present disclosure, the terminal may receive in advance beamforming information on the target AP, and may roughly adjust the beam direction in advance before the handover. For example, the terminal may receive information related to a beam together when neighboring AP information is received from the serving AP. The serving AP may report a physical direction in advance to the terminal by using location information on a neighboring AP, and the terminal may configure the beam in advance in a direction of the target AP when performing a registration procedure with respect to the AP.

A procedure in which an SP is allocated to the terminal from the serving AP may be performed.

As described above, the target AP may allocate the SP in advance to the terminal. In this case, allocation information may be provided from the target AP. According to another embodiment of the present disclosure, the allocation information may be provided from the serving AP. In other words, the SP of the target AP may be allocated to the terminal from the serving AP.

A procedure in which the terminal is registered to the target AP without a contention through a pre-allocated SP may be performed.

The terminal may perform registration procedures for registering to the target AP without a contention with other users by using the pre-allocated resource (e.g., SP). For example, the registration procedure may include a probe request/probe response, an authentication request/authentication response, and an association request/association response.

A procedure of pre-allocating a key value and association information may be performed.

If an effective interface exists between the serving AP and the target AP, the serving AP and the target AP may exchange in advance all of the information of the terminal for performing a handover, and may perform a registration procedure to be performed by the terminal in the target AP based on the exchanged information. For example, the key value and Association IDentifier (AID) may be exchanged in advance between the serving AP and the target AP, and may be provided in advance to the terminal before performing a handover procedure. According to the current standard, the key value is information provided through an authentication procedure, and the AID is information provided through an association procedure. The AID is identification information of a terminal which is unique in one AP.

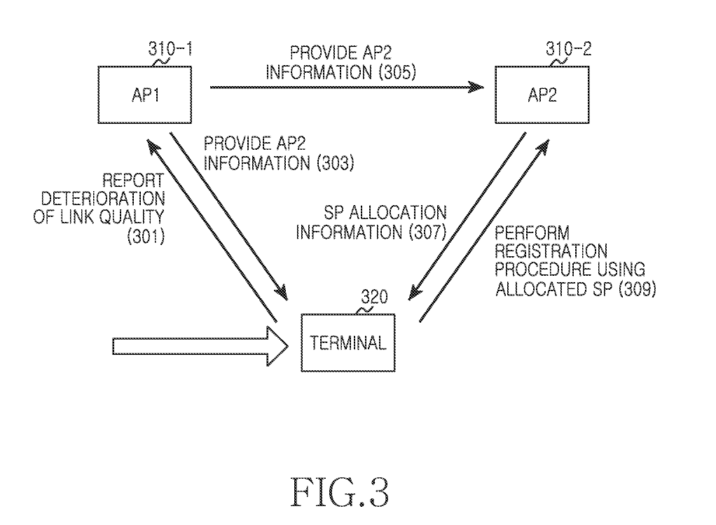

FIG. 3 illustrates a handover procedure in a wireless communication system according to an embodiment of the present disclosure. The embodiment in which resource allocation information is provided by a target AP is illustrated in FIG. 3. In FIG. 3, an AP1 310-1 is a serving AP, and an AP2 310-2 is a target AP.

Referring to FIG. 3, in operation 301, a terminal 320 recognizes that a link quality (e.g., RCPI) for the AP1 310-1 is lower than a threshold, and reports the link quality (or the deterioration of the link quality) to the AP1 310-1. The link quality may be periodically reported, or may be reported at an occurrence of a pre-defined event.

In operation 303, the AP1 310-1 instructs the terminal 320 to access the AP2 310-2. The AP1 310-1 may provide the terminal 320 with information on the AP2 310-2. For example, the information on the AP2 310-2 may include at least one of identification information of the AP2 310-2, a channel used by the AP2 310-2, beam information to be used when signal transmission/reception is performed with respect to the AP2 310-2, a key value authentication with the AP2 310-2, and an AID value to be used in the AP2 310-2.

In operation 305, the AP1 310-1 provides the AP2 310-2 with information on the terminal 320. For example, the information on the terminal 320 may include at least one of a MAC address of the terminal 320, beam information to be used when signal transmission/reception is performed with respect to the terminal 320, a key value to be used by the terminal 320 in the AP2 310-2, an AID value to be used by the terminal 320 in the AP2 310-2, and capability information of the terminal 320. Accordingly, the AP2 310-2 may allocate a resource (e.g., SP) to the terminal 320.

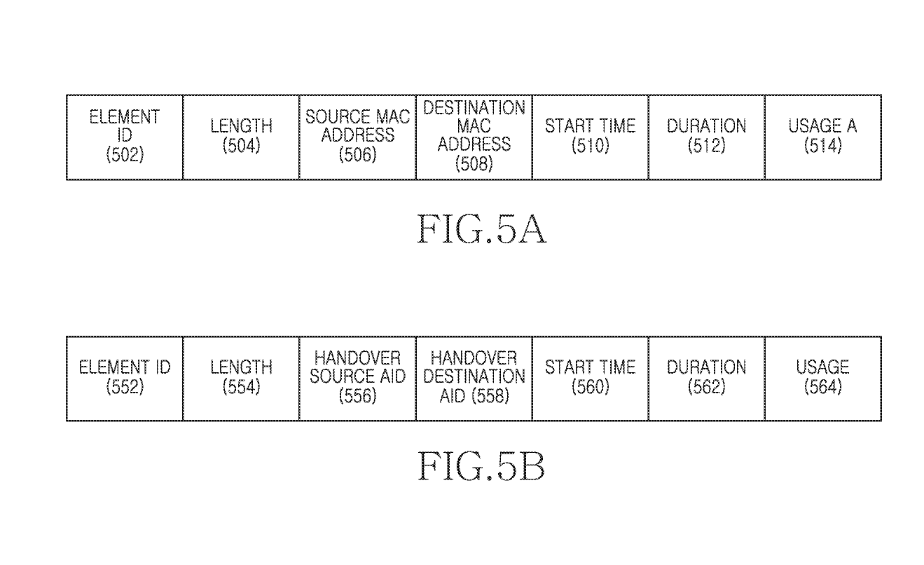

In operation 307, the AP1 310-1 transmits the resource allocation information to the terminal 320. The resource allocation information may be delivered through a modified schedule element included in a beacon. For example, the resource allocation information may be configured as shown in examples of FIGS. 5A and 5B.

In operation 309, the terminal 320 performs a registration procedure (e.g., authentication, association) through the allocated resource without a contention. The terminal 320 performs signaling for the registration by using an SP dedicated to the terminal 320.

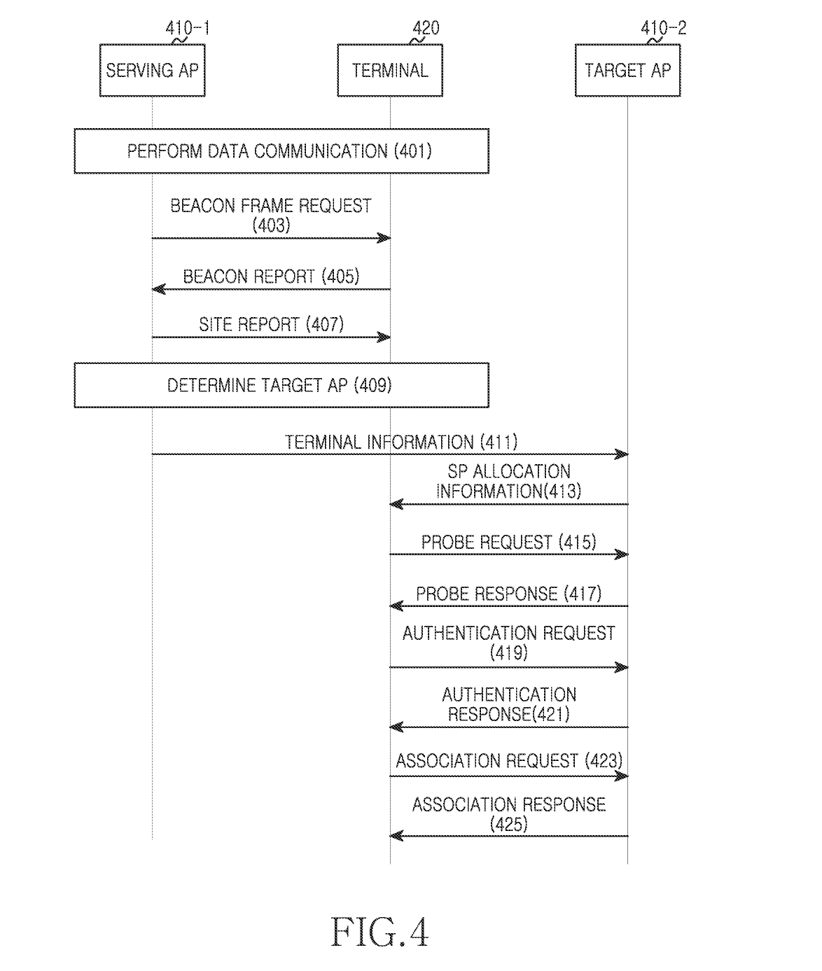

FIG. 4 illustrates a signal exchange for a handover in a wireless communication system according to an embodiment of the present disclosure. A signal exchange for a handover procedure of FIG. 3 is illustrated in FIG. 4.

Referring to FIG. 4, in operation 401, a terminal 420 and a serving AP 410-1 transmit/receive data. In this case, due to an occurrence of an obstacle on a signal path between the terminal 420 and the serving AP 410-1, a link performance between the terminal 420 and the serving AP 410-1 is gradually decreased.

In operation 403, the serving AP 410-1 transmits a beacon frame request to the terminal 420. The serving AP 410-1 requests a channel situation report through the beacon frame request. The beacon frame request may be transmitted periodically or at an occurrence of a pre-defined event.

In operation 405, the terminal 420 transmits a beacon report. The terminal 420 reports a current channel situation to the serving AP 410-1 through the beacon report. Through the beacon report, the serving AP 410-1 may determine whether a handover is performed. The beacon report may include an RCPI. In case of the aforementioned embodiment of FIG. 4, the serving AP 410-1 determines to perform the handover.

In operation 407, the serving AP 410-1 transmits a site report to the terminal 420. Through the site report, the serving AP 410-1 provides information on at least one neighboring AP to be scanned by the terminal 420. In the aforementioned embodiment of FIG. 4, the site report includes information on a target AP 410-2. For example, the information on the target AP 410-2 may include at least one of a channel used by the target AP 410-2, identification information, and information on a beam to be used by the terminal 420 in the target AP 410-2. Accordingly, the terminal 420 performs scanning based on the site report. Since only a neighboring AP indicated by the site report is scanned, a less time is consumed in comparison with scanning based on the related art. Further, if only one neighboring AP is indicated by the site report, the scanning may be omitted.

In operation 409, the serving AP 410-1 and the terminal 420 determine an AP to be newly accessed through a handover. The AP to be newly accessed may be determined based on a scanning result of the terminal 420 and a result of a beamforming protocol performed between the serving AP 410-1 and the terminal 420. For example, the serving AP 410-1 may recognize a physical location of the terminal 420 based on the result of the beamforming protocol performed between the serving AP 410-1 and the terminal 420, and thereafter may select an AP close to the location of the terminal 420. Alternatively, after the terminal 420 determines the AP to be newly accessed, it may be notified to the serving AP 410-1. The target AP 410-2 is selected as the AP to be newly accessed. If only one neighboring AP is indicated by the site report, this is a case where the AP to be newly accessed is selected before the site report is transmitted, and thus the operation 409 may be omitted.

In operation 411, the serving AP 410-1 transmits information on the terminal 420 to the target AP 410-2. For example, the information on the terminal 420 may include at least one of a MAC address of the terminal 420, beam information determined based on a location of the terminal 420 and to be used when transmission/reception is performed with respect to the terminal 420, and sector information.

In operation 413, the target AP 410-2 transmits SP allocation information to the terminal 420. The SP allocation information may include identification information of the terminal 420 to indicate the terminal 420 or may include additional identification information defined for a handover. In the embodiment of FIG. 4, the SP allocation information is transmitted once at a time. However, according to another embodiment of the present disclosure, the SP allocation information may be transmitted multiple times in a divisive manner either optionally or at an additional request. For example, the SP allocation information may be transmitted at least two times for each of a probe request/response procedure, an authentication procedure, and an association procedure to be described below.

In operation 415, the terminal 420 transmits a probe request to the target AP 410-2 by using the resource (e.g., SP) dedicated to the terminal 420 by the target AP 410-2. In operation 417, the target AP 410-2 transmits a probe response to the terminal 420 by using the resource (e.g., SP) dedicated to the terminal 420. Transmission/reception of the probe request and the probe response is a procedure of reporting a decision of performing a handover. Examples of information included in the probe response include a Service Set IDentifier (SSID) to which the target AP 410-2 belongs, identification information of the target AP 410-2, security setup, a channel, and the like.

In operation 419, the terminal 420 transmits an authentication request to the target AP 410-2 by using the resource (e.g., SP) dedicated to the terminal 420 by the target AP 410-2. In operation 421, the target AP 410-2 transmits an authentication response to the terminal 420 by using the resource (e.g., SP) dedicated to the terminal 420. The terminal 420 and the target AP 410-2 perform an authentication procedure. The authentication procedure is a procedure of determining whether the terminal 420 has a right to access the target AP 410-2. A detailed process of the authentication procedure may vary depending on a security setup of the target AP 410-2. For example, the security setup may be one of an open authentication and a shared key authentication. In case of the shared key authentication, the terminal 420 transmits a key value through the authentication request, and the target AP 410-2 transmits a response regarding whether the key value coincides with a proper key value through the authentication response, (i.e., whether an access is granted). In case of the open authentication, the terminal 420 requests whether a key value is not requested through the authentication request, and the target AP 410-2 confirms that the key value is not requested through the authentication response.

In operation 423, the terminal 420 transmits an association request to the target AP 410-2 by using the resource (e.g., SP) allocated dedicated to the terminal 420 by the target AP 410-2. In operation 425, the target AP 410-2 transmits an association response to the terminal 420 by using the resource (e.g., SP) dedicated to the terminal 420. The terminal 420 and the target AP 410-2 perform an association procedure. The association procedure is a procedure of establishing a connection between the terminal 420 and the target AP 410-2. Through the association procedure, the target AP 410-2 determines whether an association is granted. When the association is granted, the target AP 410-2 allocates an AID to the terminal 420, and transmits the AID through the association response. Otherwise, if the association is denied, the target AP 410-2 transmits a failure status code through the association response.

In the embodiment of FIG. 4, the target AP 410-2 transmits the SP allocation information to the terminal 420. According to an embodiment of the present disclosure, the SP allocation information may be configured as shown in FIGS. 5A and 5B.

FIGS. 5A and 5B illustrate examples of a message for a resource allocation in a wireless communication system according to an embodiment of the present disclosure.

Referring to FIG. 5A, the SP allocation information includes an element ID 502 indicating a type of a message, a length 504 indicating a length of the message, a source MAC address 506 indicating a MAC address of a message sender, a destination MAC address 508 indicating a MAC address of a message receiver, a start time 510 indicating an SP allocation start, a duration 512 indicating an SP allocation length, and a usage 514 indicating an allocation purpose of an allocated SP. The usage 514 may indicate at least one of a probe request/response, an authentication request/response, and an association request/response.

Referring to FIG. 5B, the SP allocation information includes an element ID 552 indicating a type of a message, a length 554 indicating a length of the message, a handover source AID 556 indicating that the allocation information is a resource allocation for a handover, a handover destination AID 558 indicating that the allocation information is a resource allocation for a handover, a start time 560 indicating an SP allocation start, a duration 562 indicating an SP allocation length, and a usage 564 indicating an allocation purpose of an allocated SP. The usage 564 may indicate at least one of a probe request/response, an authentication request/response, and an association request/response. The handover source AID 556 and the handover destination AID 558 indicate that an SP allocation is achieved for a handover, and are set to pre-defined values.

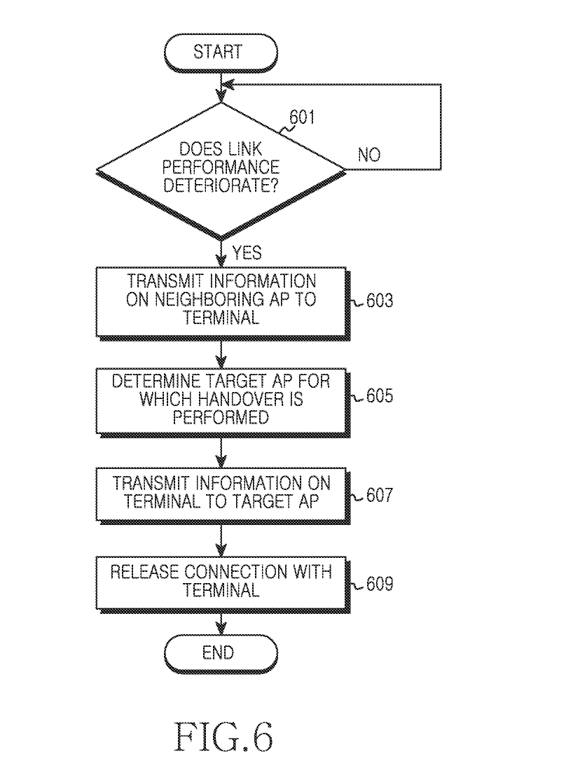

FIG. 6 illustrates a procedure of operating a serving AP in a wireless communication system according to an embodiment of the present disclosure. A procedure of operating a serving AP for a handover procedure of FIG. 3 is illustrated in FIG. 6.

Referring to FIG. 6, the serving AP determines whether a link performance with respect to a terminal deteriorates in operation 601. The serving AP may determine whether the link performance deteriorates through a link quality reported from the terminal. The serving AP determines whether the link quality is less than or equal to a threshold.

If the link performance deteriorates, then in operation 603, the serving AP transmits, to the terminal, information on at least one neighboring AP adjacent to the terminal. The AP determines a handover of the terminal, and provides information on a target for which scanning is performed for the handover. For example, based on a location of the terminal, which is determined through a beamforming protocol with respect to the terminal, the serving AP may select the at least one neighboring AP for which scanning is performed. Further, the serving AP may select a beam of the neighboring AP suitable for the terminal. The information on the neighboring AP may include a channel used by the AP, beam information to be used when signal transmission/reception is performed with respect to the AP, a key value associated with the AP, and an AID value to be used in the AP.

In operation 605, the serving AP determines a target AP. The serving AP may determine the target AP based on the scanning result upon feeding back a scanning result of the terminal. The scanning result may include a link quality for the at least one neighboring AP. Alternatively, the target AP selected by the terminal may be notified to the serving AP. If only one neighboring AP is selected in operation 603, operation 605 may be omitted. This is because the selected one neighboring AP is selected as the target AP.

After determining the target AP, the serving AP transmits information on the terminal to the target AP in operation 607. For example, the information on the terminal may include at least one of a MAC address of the terminal, beam information to be used when the target AP performs signal transmission/reception with respect to the terminal, a key value to be used by the terminal in the target AP, an AID value to be used by the terminal in the target AP, and capability information of the terminal.

In operation 609, the serving AP releases the connection with the terminal. According to another embodiment of the present disclosure, the serving AP may release the connection with the terminal after a completion of a handover of the terminal is notified from the target AP.

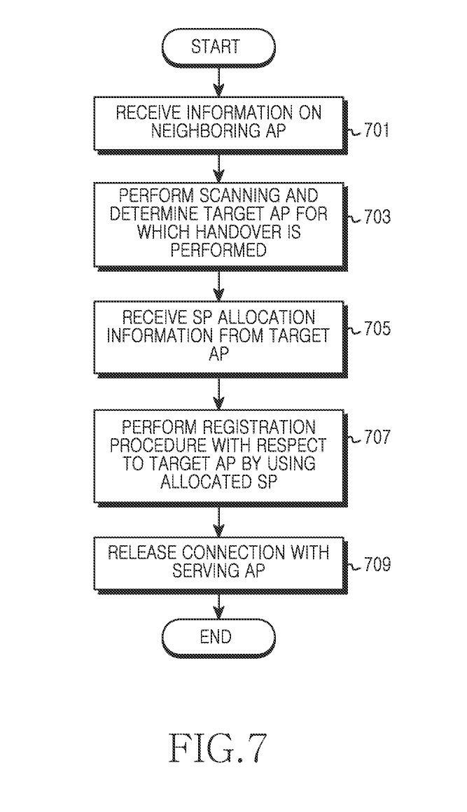

FIG. 7 illustrates a procedure of operating a terminal in a wireless communication system according to an embodiment of the present disclosure. A procedure of operating a terminal for a handover procedure of FIG. 3 is illustrated in FIG. 7.

Referring to FIG. 7, the terminal receives information on at least one neighboring AP from a serving AP in operation 701. The information on the neighboring AP is transmitted by the serving AP to indicate a handover to the terminal when a link quality between the terminal and the serving AP deteriorates. The information on the at least one neighboring AP provides information on a target for which scanning is performed for the handover. For example, the information on the at least one neighboring AP may include at least one of beam information to be used when communicating with the AP, a key value authenticated with the AP, and an AID value to be used in the AP.

In operation 703, the terminal performs scanning on the at least one neighboring AP, and determines a target AP to be newly accessed. The terminal scans the at least one neighboring AP by using information provided from the serving AP. In addition, the terminal may report a result of the scanning to the serving AP so that the serving AP selects the target AP. Alternatively, after the terminal selects the target AP, a result of the selection may be notified to the serving AP. If the information on the neighboring AP received in operation 701 includes only information on one AP, operation 703 may be omitted. This is because one neighboring AP indicated by the information on the neighboring AP is selected as the target AP.

After determining the target AP, the terminal receives SP allocation information from the target AP in operation 705. The SP allocation information indicates a resource allocated by the target AP for a registration procedure between the target AP and the terminal. The SP allocation information may indicate that the resource is a resource allocated to the terminal by using a MAC address of the terminal, or may indicate that the resource is a resource allocated to the terminal by using additional identification information defined for a handover. For example, the SP allocation information may include at least one of parameters shown in FIG. 5A or 5B.

After receiving the SP allocation information, the terminal performs a registration procedure with respect to the target AP in operation 707 by using an SP allocated by the target AP. The terminal performs signaling for the registration by using the allocated SP without a contention with other terminals. For example, the signaling for the registration may include a probe request, a probe response, an authentication request, an authentication response, an association request, and an association response.

In operation 709, the terminal releases the connection with the serving AP. According to another embodiment of the present disclosure, the terminal may release the connection with the serving AP before operation 707.

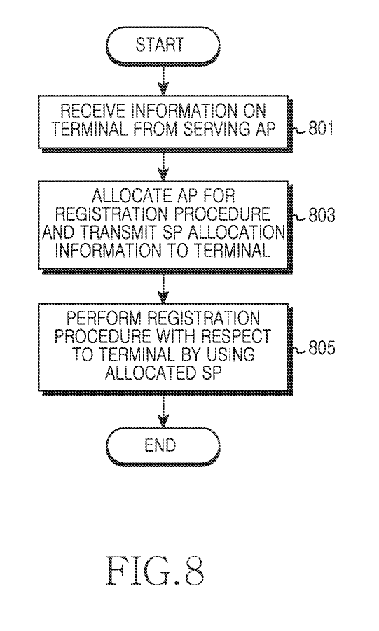

FIG. 8 illustrates a procedure of operating a target AP in a wireless communication system according to an embodiment of the present disclosure. A procedure of operating a target AP for a handover procedure of FIG. 3 is illustrated in FIG. 8.

Referring to FIG. 8, the target AP receives information on a terminal from a serving AP in operation 801. The terminal implies a terminal which intends to newly access the target AP through a handover. For example, the information on the terminal includes at least one of a MAC address of the terminal, beam information to be used when the target AP performs signal transmission/reception with respect to the terminal, a key value to be used by the terminal in the target AP, an AID value to be used by the terminal in the target AP, and capability information of the terminal.

After receiving the information on the terminal, the target AP allocates an SP for the registration procedure and transmits SP allocation information to the terminal in operation 803. The SP allocation information indicates a resource allocated by the target AP for a registration procedure between the target AP and the terminal. The SP allocation information may indicate that the resource is a resource allocated to the terminal by using a MAC address of the terminal, or may indicate that the resource is a resource allocated to the terminal by using additional identification information defined for a handover. For example, the SP allocation information may include at least one of the parameters shown in FIG. 5A or 5B.

In operation 805, the terminal performs a registration procedure with respect to the target AP by using an SP allocated by the target AP. The terminal performs signaling for the registration by using the allocated SP without a contention with other terminals. For example, the signaling for the registration may include a probe request, a probe response, an authentication request, an authentication response, an association request, and an association response.

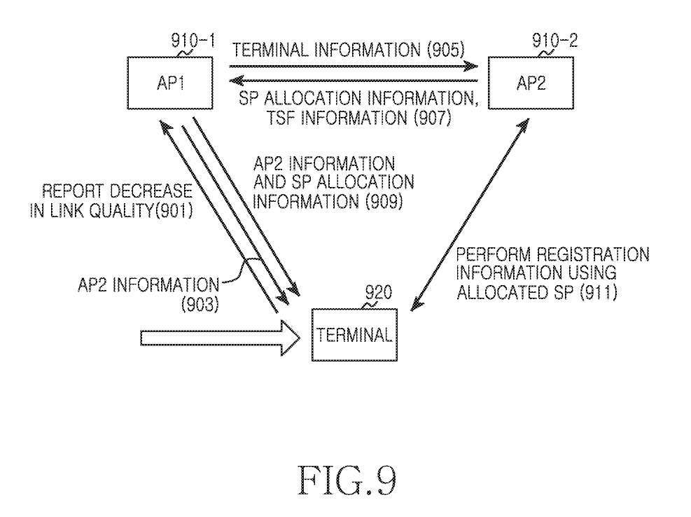

FIG. 9 illustrates a handover procedure in a wireless communication system according to another embodiment of the present disclosure. An embodiment of the present disclosure in which resource allocation information is provided via a serving AP is illustrated in FIG. 9. In FIG. 9, an AP1 910-1 is a serving AP, and an AP2 910-2 is a target AP.

Referring to FIG. 9, in operation 901, a terminal 920 recognizes that a link quality (e.g., RCPI) for the AP1 910-1 is lower than a threshold, and reports this to the AP1 910-1. The link quality may be reported periodically, or may be reported at an occurrence of a pre-defined event.

In operation 903, the AP1 910-1 instructs the terminal 920 to access the AP2 910-2. In this case, the AP1 910-1 may provide the terminal 920 with information on the AP2 910-2. For example, the information on the AP2 910-2 may include at least one of identification information of the AP2 910-2, a channel used by the AP2 910-2, beam information to be used when signal transmission/reception is performed with respect to the AP2 910-2, a key value authentication with the AP2 910-2, and an AID value to be used in the AP2 910-2.

In operation 905, the AP1 910-1 provides the AP2 910-2 with information on the terminal 920. For example, the information on the terminal 920 may include at least one of a MAC address of the terminal 920, beam information to be used when signal transmission/reception is performed with respect to the terminal 920, a key value to be used by the terminal 920 in the AP2 910-2, an AID value to be used by the terminal 920 in the AP2 910-2, and capability information of the terminal 920. Accordingly, the AP2 910-2 may allocate a resource (e.g., SP) to the terminal 920.

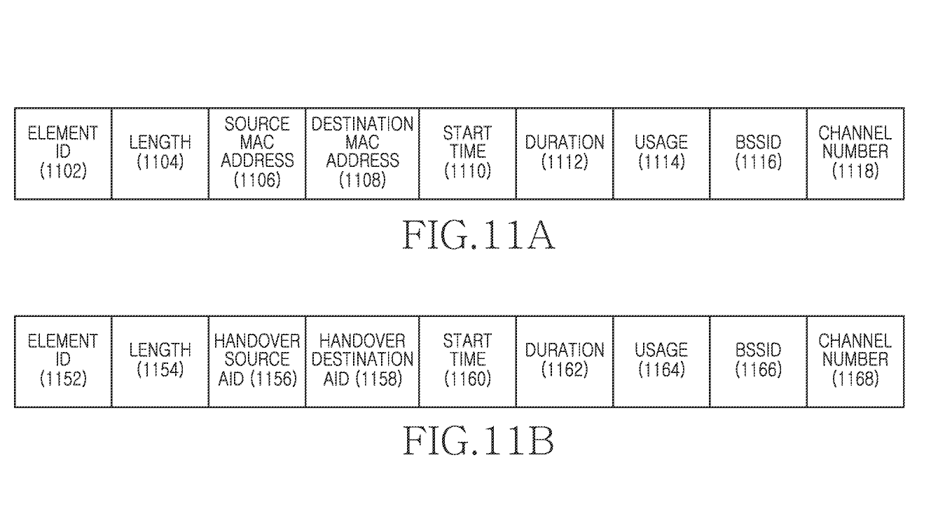

In operation 907, the AP2 910-2 allocates a resource (e.g., SP) to the terminal 920, and transmits resource allocation information and TSF information to the AP1 910-1. The resource allocation information may be delivered through a modified schedule element included in a beacon. For example, the resource allocation information may be configured as shown in FIGS. 11A and 11B.

In operation 909, the AP1 910-1 transmits the resource allocation information to the terminal 920. The resource allocation information indicates a resource allocated by the AP2 910-2. The resource allocation information includes the TSF information.

In operation 911, the terminal 920 performs a registration procedure (e.g., authentication, association) through the allocated resource without a contention. The terminal 920 performs signaling for the registration by using an SP dedicated to the terminal 920.

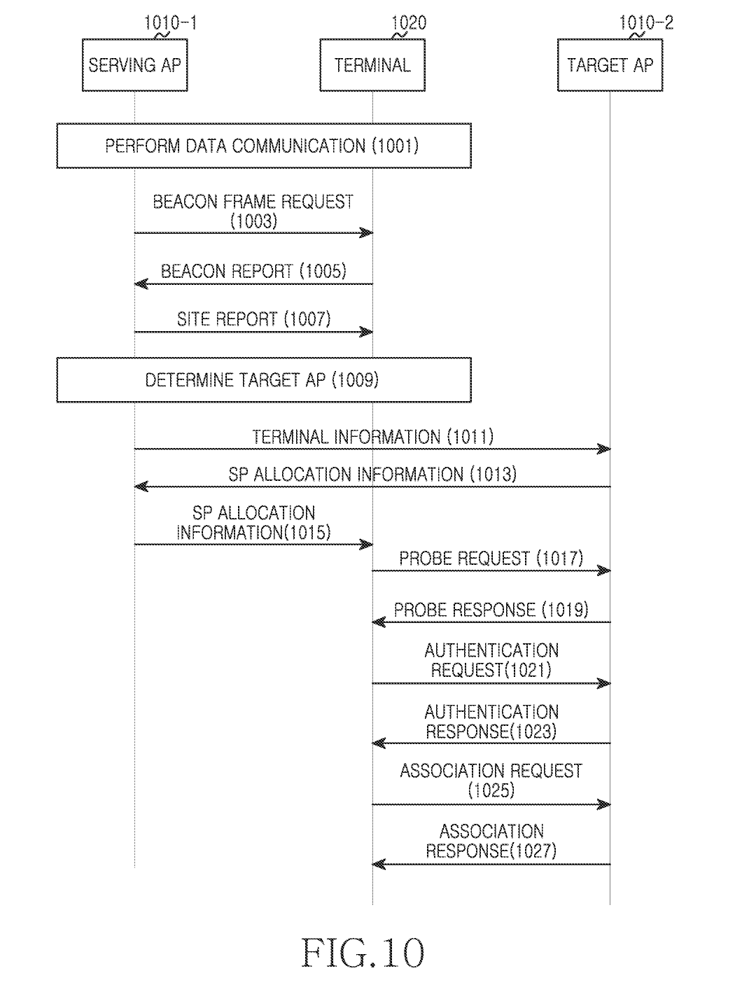

FIG. 10 illustrates a signal exchange for a handover in a wireless communication system according to another embodiment of the present disclosure. A signal exchange for a handover procedure of FIG. 9 is illustrated in FIG. 10.

Referring to FIG. 10, in operation 1001, a terminal 1020 and a serving AP 1010-1 transmit and receive data. In this case, due to an occurrence of an obstacle on a signal path between the terminal 1020 and the serving AP 1010-1, a link performance between the terminal 1020 and the serving AP 1010-1 is gradually decreased.

In operation 1003, the serving AP 1010-1 transmits a beacon frame request to the terminal 1020. The serving AP 1010-1 requests to report a channel situation through the beacon frame request. The beacon frame request may be transmitted periodically or at an occurrence of a pre-defined event.

In operation 1005, the terminal 1020 transmits a beacon report. The terminal 1020 reports a current channel situation to the serving AP 1010-1 through the beacon report. Through the beacon report, the serving AP 1010-1 may determine whether a handover is performed. The beacon report may include an RCPI. In case of the aforementioned embodiment of FIG. 4, the serving AP 1010-1 determines to perform the handover.

In operation 1007, the serving AP 1010-1 transmits a site report to the terminal 1020. Through the site report, the serving AP 1010-1 provides information on at least one neighboring AP to be scanned by the terminal 1020. In the aforementioned embodiment of FIG. 4, the site report includes information on a target AP 1010-2. For example, the information on the target AP 1010-2 may include at least one of a channel used by the target AP 1010-2, identification information, and information on a beam to be used by the terminal 1020 in the target AP 1010-2. Accordingly, the terminal 1020 performs scanning based on the site report. Since only a neighboring AP indicated by the site report is scanned, less time is consumed in comparison with scanning according to the related art. Further, if only one neighboring AP is indicated by the site report, the scanning may be omitted.

In operation 1009, the serving AP 1010-1 and the terminal 1020 determine an AP to be newly accessed through a handover. The AP to be newly accessed may be determined based on a scanning result of the terminal 1020 and a result of a beamforming protocol performed between the serving AP 1010-1 and the terminal 1020. For example, the serving AP 1010-1 may recognize a physical location of the terminal 1020 based on the result of the beamforming protocol performed between the serving AP 1010-1 and the terminal 1020, and thereafter may select an AP close to the location. Alternatively, after the terminal 1020 determines the AP to be newly accessed, the terminal 1020 may be notified to the serving AP 1010-1. The target AP 1010-2 is selected as the AP to be newly accessed. If only one neighboring AP is indicated by the site report, this is a case where the AP to be newly accessed is selected before the site report is transmitted, and thus the operation 1009 may be omitted.

In operation 1011, the serving AP 1010-1 transmits information on the terminal 1020 to the target AP 1010-2. For example, the information on the terminal 1020 may include at least one of a MAC address of the terminal 1020, beam information determined based on a location of the terminal 1020 and to be used when transmission/reception is performed with respect to the terminal 1020, and sector information.

In operation 1013, the target AP 1010-2 transmits SP allocation information to the serving AP 1010-1. In addition to the SP allocation information, TSF related information may be further transmitted. The TSF related information may include a TSF offset to indicate a difference between a TSF of the serving AP 1010-1 and a TSF of the target AP 1010-2.

In operation 1015, the serving AP 1010-1 transmits the AP allocation information to the terminal 1020. The SP allocation information may include identification information of the terminal 1020 to indicate the terminal 1020 or may include additional identification information defined for a handover. In the embodiment of FIG. 10, the SP allocation information is transmitted once. However, according to another embodiment of the present disclosure, the SP allocation information may be transmitted multiple times in a divisive manner either optionally or at an additional request. For example, the SP allocation information may be transmitted at least two times for each of a probe request/response procedure, an authentication procedure, and an association procedure to be described below.

In operation 1017, the terminal 1020 transmits a probe request to the target AP 1010-2 by using a resource (e.g., SP) dedicated to the terminal 1020 by the target AP 1010-2. In operation 1019, the target AP 1010-2 transmits a probe response to the terminal 1020 by using the resource (e.g., SP) dedicated to the terminal 1020. Transmission/reception of the probe request and the probe response is a procedure of reporting a decision of performing a handover. Examples of information included in the probe response include a Service Set IDentifier (SSID) to which the target AP 1010-2 belongs, identification information of the target AP 1010-2, security setup, a channel, and the like.

In operation 1021, the terminal 1020 transmits an authentication request to the target AP 1010-2 by using the resource (e.g., SP) dedicated to the terminal 1020 by the target AP 1010-2. In operation 1023, the target AP 1010-2 transmits an authentication response to the terminal 1020 by using the resource (e.g., SP) dedicated to the terminal 1020. The terminal 1020 and the target AP 1010-2 perform an authentication procedure. The authentication procedure is a procedure of determining whether the terminal 1020 has a right to access the target AP 1010-2. A detailed process of the authentication procedure may vary depending on a security setup of the target AP 1010-2. For example, the security setup may be one of an open authentication and a shared key authentication. In case of the shared key authentication, the terminal 1020 transmits a key value through the authentication request, and the target AP 1010-2 transmits a response regarding whether the key value coincides with a proper key value through the authentication response (i.e., whether access is granted). In case of the open authentication, the terminal 1020 requests whether a key value is not requested through the authentication request, and the target AP 1010-2 confirms that the key value is not requested through the authentication response.

In operation 1025, the terminal 1020 transmits an association request to the target AP 1010-2 by using the resource (e.g., SP) dedicated to the terminal 1020 by the target AP 1010-2. In operation 1027, the target AP 1010-2 transmits an association response to the terminal 1020 by using the resource (e.g., SP) dedicated to the terminal 1020. The terminal 1020 and the target AP 1010-2 perform an association procedure. The association procedure is a procedure of establishing a connection between the terminal 1020 and the target AP 1010-2. Through the association procedure, the target AP 1010-2 determines whether an association is granted. When the association is granted, the target AP 1010-2 allocates an AID to the terminal 1020, and transmits the AID through the association response. Otherwise, if the association is denied, the target AP 1010-2 transmits a failure status code through the association response.

In the embodiment of FIG. 10, the target AP 1010-2 transmits the SP allocation information to the terminal 1020. According to various embodiments of the present disclosure, the SP allocation information may be configured as shown in FIGS. 11A and 11B.

FIGS. 11A and 11B illustrate examples of a message for a resource allocation in a wireless communication system according to another embodiment of the present disclosure.

Referring to FIG. 11A, the SP allocation information includes an element ID 1102 indicating a type of a message, a length 1104 indicating a length of the message, a source MAC address 1106 indicating a MAC address of a message sender, a destination MAC address 1108 indicating a MAC address of a message receiver, a start time 1110 indicating an SP allocation start, a duration 1112 indicating an SP allocation length, a usage 1114 indicating an allocation purpose of an allocated SP, a Basic Service Set IDentifier (BSSID) 1116 indicating a name of a network to which a corresponding AP belongs, and a channel number 1118 indicating a channel used by the corresponding AP. The usage 1114 may indicate at least one of a probe request/response, an authentication request/response, and an association request/response.

Referring to FIG. 11B, the SP allocation information includes an element ID 1152 indicating a type of a message, a length 1154 indicating a length of the message, a handover source AID 1156 indicating that the SP allocation information is a resource allocation for a handover, a handover destination AID 1158 indicating that the SP allocation information is a resource allocation for a handover, a start time 1160 indicating an SP allocation start, a duration 1162 indicating an SP allocation length, a usage 1164 indicating an allocation purpose of an allocated SP, a BSSID 1166 indicating a name of a network to which a corresponding AP belongs, and a channel number 1168 indicating a channel used by the corresponding AP. The usage 1164 may indicate at least one of a probe request/response, an authentication request/response, and an association request/response. The handover source AID 1156 and the handover destination AID 1158 indicate that an SP allocation is achieved for a handover, and are set to pre-defined values.

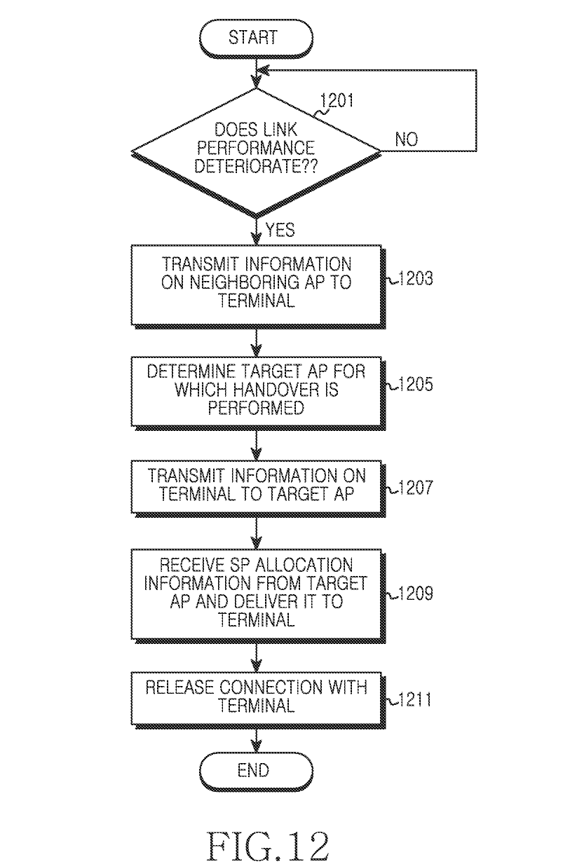

FIG. 12 illustrates a procedure of operating a serving AP in a wireless communication system according to another embodiment of the present disclosure. A procedure of operating a serving AP for a handover procedure of FIG. 9 is illustrated in FIG. 12.

Referring to FIG. 12, the serving AP determines whether a link performance with respect to a terminal deteriorates in operation 1201. The serving AP may determine whether the link performance deteriorates through a link quality reported from the terminal. The serving AP determines whether the link quality is less than or equal to a threshold.

If the link performance deteriorates, then in operation 1203, the serving AP transmits, to the terminal, information on at least one neighboring AP adjacent to the terminal. The AP determines a handover of the terminal, and provides information on a target for which scanning is performed for the handover. For example, based on a location of the terminal, which is determined through a beamforming protocol with respect to the terminal, the serving AP may select the at least one neighboring AP for which scanning is performed. The serving AP may select a beam of the neighboring AP suitable for the terminal. The information on the neighboring AP may include a channel used by the AP, beam information to be used when signal transmission/reception is performed with respect to the AP, a key value associated with the AP, and an AID value to be used in the AP.

In operation 1205, the serving AP determines a target AP. The serving AP may determine the target AP based on the basis scanning result upon feeding back a scanning result of the terminal. The scanning result may include a link quality for the at least one neighboring AP. Alternatively, the target AP selected by the terminal may be notified to the serving AP. If only one neighboring AP is selected in the operation 1203, the operation 1205 may be omitted. This is because the selected one neighboring AP is selected as the target AP.

After determining the target AP, the serving AP transmits information on the terminal to the target AP in operation 1207. For example, the information on the terminal may include at least one of a MAC address of the terminal, beam information to be used when the target AP performs signal transmission/reception with respect to the terminal, a key value to be used by the terminal in the target AP, an AID value to be used by the terminal in the target AP, and capability information of the terminal.

After transmitting the information on the terminal, the serving AP receives SP allocation information for the terminal from the target AP in operation 1209. In addition, the serving AP delivers the SP allocation information to the terminal. The SP allocation information indicates a resource allocated by the target AP for a registration procedure between the terminal and the target AP. The SP allocation information may indicate that the resource is a resource allocated to the terminal by using a MAC address of the terminal, or may indicate that the resource is a resource allocated to the terminal by using additional identification information defined for a handover. For example, the SP allocation information may include at least one of parameters shown in FIG. 11A or 11B. In addition to the SP allocation information, the serving AP may further transmit TSF related information to the terminal. The TSF related information may include a TSF offset to indicate a difference between a TSF of the serving AP and a TSF of the target AP. The TSF offset may be calculated by the serving AP, or may be provided from the target AP.

In operation 1211, the serving AP releases the connection with the terminal. According to another embodiment of the present disclosure, the serving AP may release the connection with the terminal after a completion of a handover of the terminal is notified from the target AP.

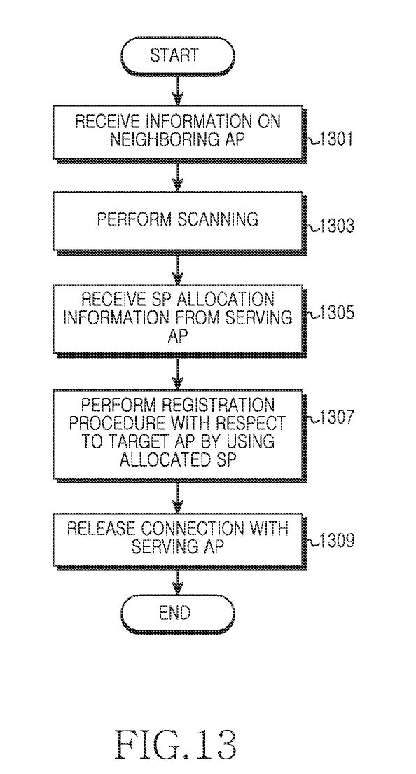

FIG. 13 illustrates a procedure of operating a terminal in a wireless communication system according to an embodiment of the present disclosure. A procedure of operating a terminal for a handover procedure of FIG. 9 is illustrated in FIG. 13.

Referring to FIG. 13, the terminal receives information on at least one neighboring AP from a serving AP in operation 1301. The information on the neighboring AP is transmitted by the serving AP to indicate a handover to the terminal when a link quality between the terminal and the serving AP deteriorates. The information on the at least one neighboring AP provides information on a target for which scanning is performed for the handover. For example, the information on the at least one neighboring AP may include at least one of beam information to be used when communicating with the AP, a key value authenticated with the AP, and an AID value to be used in the AP.

In operation 1303, the terminal performs scanning on the at least one neighboring AP, and determines a target AP to be newly accessed. The terminal scans the at least one neighboring AP by using information provided from the serving AP. In addition, the terminal may report a result of the scanning to the serving AP so that the serving AP selects the target AP. Alternatively, after the terminal selects the target AP, a result of the selection may be notified to the serving AP. If the information on the neighboring AP received in the operation 1301 includes only information on one AP, operation 1303 may be omitted. This is because one neighboring AP indicated by the information on the neighboring AP is selected as the target AP.

After determining the target AP, the serving AP receives SP allocation information from the serving AP in operation 1305. The SP allocation information indicates a resource allocated by the target AP for a registration procedure between the target AP and the terminal. In case of the embodiment of FIG. 13, the SP allocation information is delivered via the serving AP. The SP allocation information may indicate that it is a resource allocated to the terminal by using a MAC address of the terminal, or may indicate that it is a resource allocated to the terminal by using additional identification information defined for a handover. For example, the SP allocation information may include at least one of parameters shown in FIG. 5A or 5B.

After receiving the SP allocation information, the terminal performs a registration procedure with respect to the target AP in operation 1307 by using an SP allocated by the target AP. Specifically, the terminal performs signaling for the registration by using the allocated SP without a contention with other terminals. For example, the signaling for the registration may include a probe request, a probe response, an authentication request, an authentication response, an association request, and an association response.

In operation 1309, the terminal releases the connection with the serving AP. According to another embodiment of the present disclosure, the terminal may release the connection with the serving AP before the operation 1307.

In the embodiment of FIG. 13, the terminal receives the SP allocation information from the serving AP. In this case, in addition to the SP allocation information, the terminal may further receive TSF related information. The TSF related information may include a TSF offset to indicate a difference between a TSF of the serving AP and a TSF of the target AP. The terminal may synchronize with the target AP by using the TSF related information.

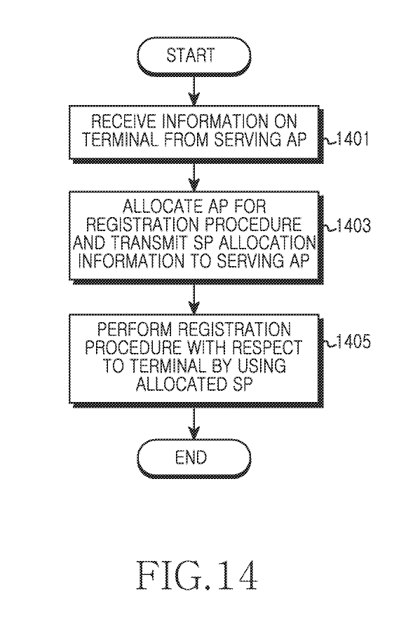

FIG. 14 illustrates a procedure of operating a target AP in a wireless communication system according to an embodiment of the present disclosure. A procedure of operating a target AP for a handover procedure of FIG. 9 is illustrated in FIG. 14.

Referring to FIG. 14, the target AP receives information on a terminal from a serving AP in operation 1401. The terminal may be a terminal which intends to newly access the target AP through a handover. For example, the information on the terminal includes at least one of a MAC address of the terminal, beam information to be used when the target AP performs signal transmission/reception with respect to the terminal, a key value to be used by the terminal in the target AP, an AID value to be used by the terminal in the target AP, and capability information of the terminal.

After receiving the information on the terminal, the target AP allocates an SP for the registration procedure and transmits SP allocation information to the serving AP in operation 1403. The SP allocation information indicates a resource allocated by the target AP for a registration procedure between the target AP and the terminal. The SP allocation information may indicate that the resource is a resource allocated to the terminal by using a MAC address of the terminal, or may indicate that the resource is a resource allocated to the terminal by using additional identification information defined for a handover. For example, the SP allocation information may include at least one of parameters shown in FIG. 5A or 5B. In addition to the SP allocation information, the target AP may further transmit TSF related information to the terminal. The TSF related information may include a TSF offset to indicate a difference between a TSF of the target AP or a TSF of the serving AP and a TSF of the target AP.

In operation 1405, the terminal performs a registration procedure with respect to the target AP by using an SP allocated by the target AP. The terminal performs signaling for the registration by using the allocated SP without a contention with other terminals. For example, the signaling for the registration may include a probe request, a probe response, an authentication request, an authentication response, an association request, and an association response.

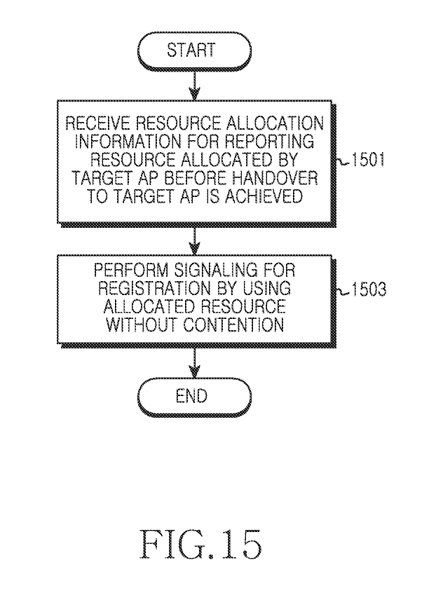

FIG. 15 illustrates a procedure of operating a terminal in a wireless communication system according to another embodiment of the present disclosure. A procedure of operating a terminal which intends to perform a handover from a serving AP to a target AP is illustrated in FIG. 15.

Referring to FIG. 15, in operation 1501, the terminal receives resource allocation information for reporting a resource allocated by the target AP before a handover to the target AP is achieved. The terminal intends to perform the handover to the target AP. The terminal may receive the resource allocation information directly from the target AP, or may receive the resource allocation information via the serving AP. The resource allocation information may indicate that the resource is a resource allocated to the terminal by using a MAC address of the terminal, or may indicate that the resource is a resource allocated to the terminal by using additional identification information defined for a handover. For example, the resource allocation information may be configured as shown in FIGS. 5A and 5B and FIGS. 11A and 11B. According to another embodiment of the present disclosure, the terminal may further receive TSF related information of the target AP in addition to the resource allocation information. The TSF related information may include a TSF offset to indicate a difference between a TSF of the serving AP and a TSF of the target AP.

In operation 1503, the terminal performs signaling for a registration with respect to the target AP, without a contention with other terminals, by using a resource allocated by the target AP. In other words, the terminal performs a registration procedure by using a resource dedicated to the terminal without a contention with other terminals. For example, the signaling for the registration may include a probe request, a probe response, an authentication request, an authentication response, an association request, and an association response. Accordingly, the terminal may perform the handover without a time delay caused by the contention.

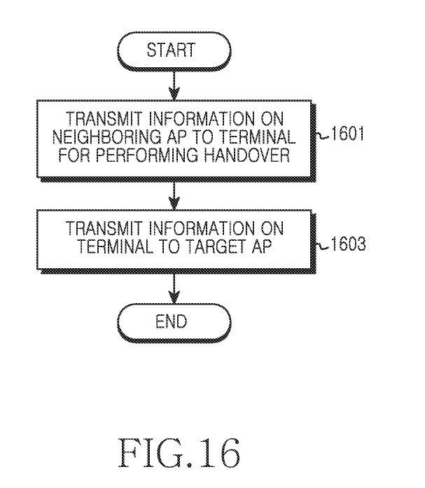

FIG. 16 illustrates a procedure of operating a serving AP in a wireless communication system according to another embodiment of the present disclosure. A procedure of operating an AP in which a terminal accessed thereto intends to perform a handover to another AP is illustrated in FIG. 16.

Referring to FIG. 16, in operation 1601, the serving AP transmits information on at least one neighboring AP to the terminal for performing a handover. The serving AP determines the handover of the terminal based on a link quality, and provides information on a target for which scanning is performed for the handover. The information on the neighboring AP may include at least one of a channel used by the AP, beam information to be used when signal transmission/reception is performed with respect to the AP, a key value authenticated with the AP, and an AID value to be used in the AP.

In operation 1603, the serving AP transmits information on the terminal to the target AP to which a handover is performed by the terminal. For example, the information on the terminal includes at least one of a MAC address of the terminal, beam information to be used when the target AP performs signal transmission/reception with respect to the terminal, a key value to be used by the terminal in the target AP, an AID value to be used by the terminal in the target AP, and capability information of the terminal.

Although not shown in FIG. 16, before transmitting the information on the terminal, the serving AP may determine the target AP. For example, the serving AP may determine the target AP based on the scanning result upon feeding back a scanning result of the terminal. For another example, the target AP selected by the terminal may be notified to the serving AP. If only one neighboring AP is included in the neighboring AP information transmitted in the operation 1601, since the one AP is the target AP, the operation of determining the target AP may be omitted.

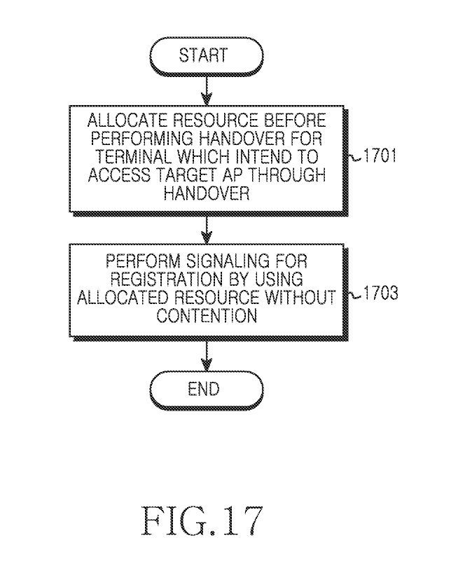

FIG. 17 illustrates a procedure of operating a target AP in a wireless communication system according to another embodiment of the present disclosure. A procedure of operating an AP in which a terminal which has an access to a neighboring AP intends to access the AP through a handover is illustrated in FIG. 17.

Referring to FIG. 17, in operation 1701, for a terminal which intends to access the target AP through a handover, the target AP allocates a resource before performing the handover. The target AP allocates the resource to the terminal, even if the terminal does not yet access the target AP. The target AP allocates the resource to a terminal which has an access to another AP other than the target AP.

In operation 1703, the target AP performs, without a contention, signaling for a registration with respect to the terminal by using a resource allocated by the target AP. The target AP performs a registration procedure by using a resource dedicated to the terminal. For example, the signaling for the registration may include a probe request, a probe response, an authentication request, an authentication response, an association request, and an association response. Accordingly, the terminal may perform a handover without a time delay caused by a contention.

Although not shown in FIG. 17, before the signaling for the registration is performed, the target AP may transmit resource allocation information for reporting the resource allocated to the terminal. In this case, the target AP may transmit the resource allocation information directly to the terminal or via a current serving AP of the terminal. The resource allocation information may indicate that the resource is a resource allocated to the terminal by using a MAC address of the terminal, or may indicate that the resource is a resource allocated to the terminal by using additional identification information defined for a handover. For example, the resource allocation information may be configured as shown in FIGS. 5A and 5B and FIGS. 11A and 11B. According to another embodiment of the present disclosure, the target AP may further transmit TSF related information of the target AP in addition to the resource allocation information. The TSF related information may include a TSF offset to indicate a difference between a TSF of the serving AP and a TSF of the target AP.

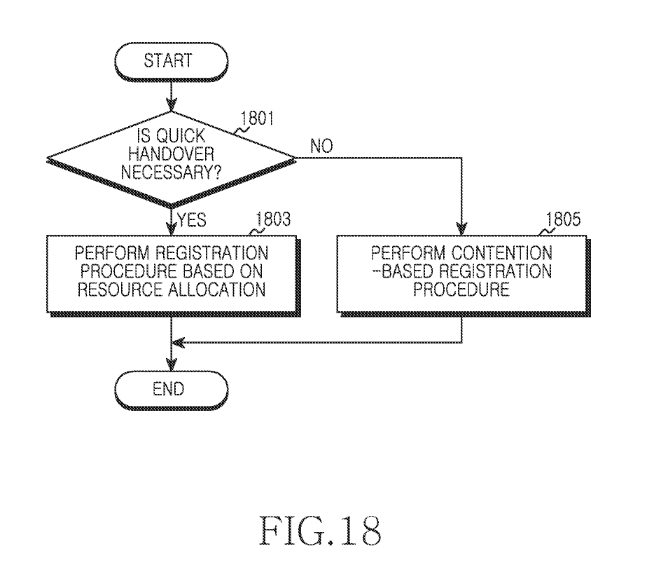

FIG. 18 illustrates a procedure of operating a serving AP in a wireless communication system according to another embodiment of the present disclosure. A procedure of operating an AP in which a terminal which has an access thereto intends to perform a handover to another AP is illustrated in FIG. 16.

Referring to FIG. 18, the serving AP determines in operation 1801 whether a quick handover is necessary for the terminal. The quick handover is an operation in which a registration procedure with respect to a target AP is dedicated to the terminal. According to an embodiment of the present disclosure, the serving AP may determine whether the quick handover is necessary according to a type of a service provided to the terminal. For example, if a service sensitive to a delay such as a real time based service (e.g., Voice over Internet Protocol (VoIP), streaming) is provided to the terminal, the serving AP may determine that the quick handover is necessary. The serving AP may determine the type of the service provided to the terminal based on a type of a connection established with the terminal, a header of a packet transmitted to the terminal, and the like.

If it is determined that the quick handover is necessary, then in operation 1803, the serving AP provides control to perform a registration procedure based on a resource allocation. The serving AP provides information on the terminal to the target AP to provide control such that a resource can be allocated to the terminal before the terminal accesses the target AP. For example, the serving AP operates as shown in FIG. 16 described above.

If it is determined that the quick handover is not necessary, then in operation 1805, the serving AP provides control to perform a contention-based registration procedure. By operating according to a typical handover procedure, the serving AP controls the terminal to occupy a resource for a registration with respect to the target AP through a contention with other terminals.

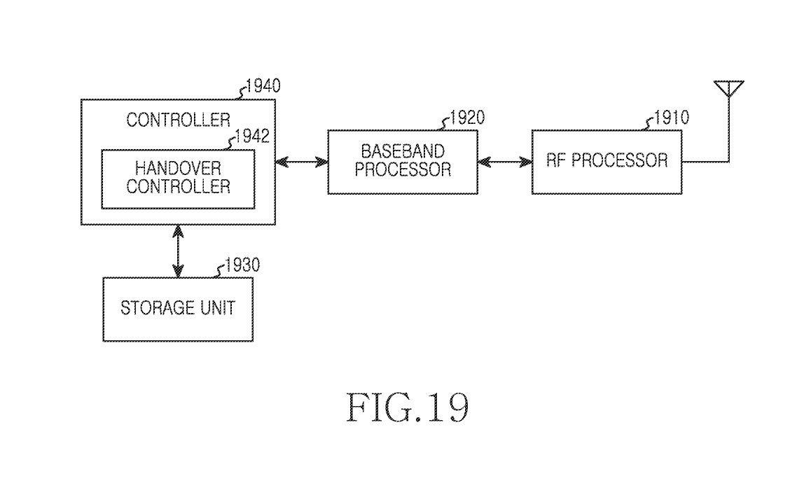

FIG. 19 is a block diagram of a terminal in a wireless communication system according to an embodiment of the present disclosure.

Referring to FIG. 19, the terminal includes a Radio Frequency (RF) processor 1910, a baseband processor 1920, a storage unit 1930, and a controller 1940.

The RF processor 1910 transmits/receives a signal through a radio channel by using signal band conversion, amplification, and the like. The RF processor 1910 up-converts a baseband signal provided from the baseband processor 1920 into an RF signal and thereafter transmits it through an antenna, and down-converts an RF signal received via the antenna into a baseband signal. For example, the RF processor 1910 may include a transmission filter, a reception filter, an amplifier, a mixer, an oscillator, a Digital to Analog Convertor (DAC), an Analog to Digital Convertor (ADC), and the like. Although only one antenna is illustrated in FIG. 19, the terminal may include a plurality of antennas. In addition, the RF processor 1910 may include a plurality of RF chains.

The baseband processor 1920 converts between a baseband signal and a bit-stream according to a physical layer standard of a system. For example, in data transmission, the baseband processor 1920 generates complex symbols by coding and modulating a transmission bit-stream. In addition, in data reception, the baseband processor 1920 restores a reception bit-stream by demodulating and decoding a baseband signal provided from the RF processor 1910. The baseband processor 1920 and the RF processor 1910 transmit and receive a signal as described above. Accordingly, the baseband processor 1920 and the RF processor 1910 may be called a transmitter, a receiver, a transceiver, or a communication unit.

The storage unit 1930 stores data such as a basic program for an operation of the terminal, an application program, setup information, and the like. In addition, the storage unit 1930 provides the stored data at a request of the controller 1940.

The controller 1940 controls overall operations of the terminal. For example, the controller 1940 transmits/receives a signal via the baseband processor 1920 and the RF processor 1910. According to an embodiment of the present disclosure, the controller 1940 includes a handover controller 1942 to provide control to perform a registration procedure with respect to a target AP by using a resource pre-allocated from the target AP before performing a handover. For example, the controller 1940 controls the terminal to perform the procedure illustrated in any one of FIG. 7, FIG. 13, and FIG. 15.

The controller 1940 receives resource allocation information for reporting a resource allocated by the target AP before performing a handover to the target AP via the RF processor 1910 and the baseband processor 1920. The resource allocation information may be received directly from the target AP, or may be received via the serving AP. The resource allocation information may indicate that the resource is a resource allocated to the terminal by using a MAC address of the terminal, or may indicate that the resource is a resource allocated to the terminal by using additional identification information defined for a handover. For example, the resource allocation information may be configured as shown in FIGS. 5A and 5B and FIGS. 11A and 11B. According to another embodiment of the present disclosure, the controller 1940 may further receive TSF related information of the target AP in addition to the resource allocation information. The TSF related information may include a TSF offset to indicate a difference between a TSF of the serving AP and a TSF of the target AP.

Upon receiving the resource allocation information, the controller 1940 performs signaling for a registration with respect to the target AP, without a contention with other terminals, by using a resource allocated by the target AP. For example, the signaling for the registration may include a probe request, a probe response, an authentication request, an authentication response, an association request, and an association response. Accordingly, the controller 1940 may perform the handover without a time delay caused by the contention.

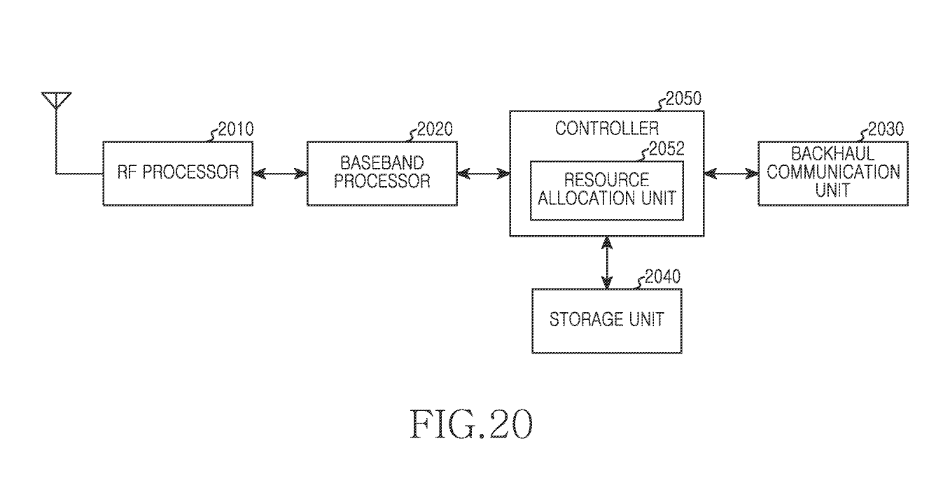

FIG. 20 is a block diagram of an AP in a wireless communication system according to an embodiment of the present disclosure.

Referring to FIG. 20, the AP includes an RF processor 2010, a baseband processor 2020, a backhaul communication unit 2030, a storage unit 2040, and a controller 2050.

The RF processor 2010 transmits/receives a signal through a radio channel by using signal band conversion, amplification, and the like. The RF processor 2010 up-converts a baseband signal provided from the baseband processor 2020 into an RF signal and thereafter transmits the signal through an antenna, and down-converts an RF signal received via the antenna into a baseband signal. Although only one antenna is illustrated in FIG. 20, the AP may include a plurality of antennas. In addition, the RF processor 2010 may include a plurality of RF chains.

The baseband processor 2020 converts between a baseband signal and a bit-stream according to a physical layer standard of a system. For example, in data transmission, the baseband processor 2020 generates complex symbols by coding and modulating a transmission bit-stream. In addition, in data reception, the baseband processor 2020 restores a reception bit-stream by demodulating and decoding a baseband signal provided from the RF processor 2010. The baseband processor 2020 and the RF processor 2010 transmit and receive a signal as described above. Accordingly, the baseband processor 2020 and the RF processor 2010 may be called a transmitter, a receiver, a transceiver, or a communication unit.

The backhaul communication unit 2030 provides an interface for performing communication with other nodes in a network. The backhaul communication unit 2030 converts a bit-stream transmitted from the AP to a different node, e.g., another AP, code network, and the like, into a physical signal, and converts a physical signal received from the different node into a bit-stream. The storage unit 2040 stores data such as a basic program for an operation of the AP, an application program, setup information, and the like. In addition, the storage unit 2040 provides the stored data at a request of the controller 2050.

The controller 2050 controls overall operations of the AP. For example, the controller 2050 transmits/receives a signal via the baseband processor 2020 and the RF processor 2010 or via the backhaul communication unit 2030. In addition, the controller 2050 writes data in the storage unit 2040. According to an embodiment of the present disclosure, the controller 2050 includes a resource allocation unit 2052 for allocating a resource to the terminal. For example, the controller 2050 may control the AP to perform the procedure illustrated in any one of FIG. 6, FIG. 8, FIG. 12, FIG. 14, FIG. 16, FIG. 17, and FIG. 18.

If the AP operates as a serving AP, the controller 2050 determines whether a quick handover is necessary for the terminal. According to an embodiment of the present disclosure, the controller 2050 may determine whether the quick handover is necessary according to a type of a service provided to the terminal. For example, if a service sensitive to a delay such as a real time based service is provided to the terminal, the controller 2050 may determine that the quick handover is necessary. If it is determined that the quick handover is necessary, the controller 2050 provides control to perform a registration procedure based on a resource allocation. The controller 2050 provides information on the terminal to the target AP to provide control such that a resource can be allocated to the terminal before the terminal accesses the target AP.

If the AP operates as the serving AP, the controller 2050 transmits information on at least one neighboring AP to a terminal for performing a handover. The information on the neighboring AP may include a channel used by the AP, beam information to be used when signal transmission/reception is performed with respect to the AP, a key value associated with the AP, and an AID value to be used in the AP. In addition, the controller 2050 transmits information on the terminal to the target AP for which the terminal performs a handover. For example, the information on the terminal may include at least one of a MAC address of the terminal, beam information to be used when the target AP performs signal transmission/reception with respect to the terminal, a key value to be used by the terminal in the target AP, an AID value to be used by the terminal in the target AP, and capability information of the terminal. In this case, the controller 2050 may determine the target AP. For example, the controller 2050 may determine the target AP based on the scanning result upon feeding back a scanning result of the terminal. For another example, the target AP selected by the terminal may be notified to the controller 2050. If only one neighboring AP is included in the neighboring AP information transmitted in, since the one AP is the target AP, the operation of determining the target AP may be omitted.

If the AP operates as a target AP, for a terminal which intends to access the target AP through a handover, the controller 2050 allocates a resource before performing the handover. The controller 2050 allocates the resource to the terminal, even if the terminal does not yet access the target AP. For this, the controller 2050 may receive information on the terminal from a current serving AP of the terminal via the backhaul communication unit 2030. In addition, the controller 2050 performs signaling for a registration with respect to the terminal by using the allocated resource. For example, the signaling for the registration may include a probe request, a probe response, an authentication request, an authentication response, an association request, and an association response. Accordingly, the terminal may perform the handover without a time delay caused by the contention.

If the AP operates as the target AP, before performing the signaling, the controller 2050 may transmit resource allocation information for reporting a resource allocated to the terminal. In this case, the controller 2050 may transmit the resource allocation information directly to the terminal via the RF processor 2010 and the baseband processor 2020, or via a current serving AP of the terminal via the backhaul communication unit 2030. The resource allocation information may indicate that the resource is a resource allocated to the terminal by using a MAC address of the terminal, or may indicate that the resource is a resource allocated to the terminal by using additional identification information defined for a handover. For example, the resource allocation information may be configured as shown in FIGS. 5A and 5B and FIGS. 11A and 11B. According to another embodiment of the present disclosure, the controller 2050 may further receive TSF related information of the target AP in addition to the resource allocation information. The TSF related information may include a TSF offset to indicate a difference between a TSF of the serving AP and a TSF of the target AP.

Since a resource for signaling of a registration procedure is dedicated to a terminal which performs a handover in a wireless communication system, a time delay consumed in a contention for occupying a resource by the terminal is decreased, thereby being able to decrease a handover time. Accordingly, a seamless handover can be performed.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

In the aforementioned specific embodiments of the present disclosure, a constitutional element included in the disclosure is expressed in a singular or plural form according to the specific embodiment proposed herein. However, the singular or plural expression is selected properly for a situation proposed for the convenience of explanation, and thus the disclosure is not limited to a single or a plurality of constitutional elements. Therefore, a constitutional element expressed in a plural form can also be expressed in a singular form, or vice versa.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating a terminal in a wireless communication system, the method comprising:
receiving resource allocation information for reporting a resource allocated by a target Access Point (AP) before accessing the target AP for a handover; and
transmitting a signal for a registration to the target AP through a resource indicated by the resource allocation information.

2. The method of claim 1, wherein the resource allocation information indicates that the resource is a resource allocated to the terminal by using a Media Access Control (MAC) address of the terminal and additional identification information defined for the handover.

3. The method of claim 1, wherein the resource allocation information comprises information on a Service Period (SP) allocated to the terminal.

4. The method of claim 1, wherein the signal for the registration comprises at least one of a probe request, an authentication request, and an association request.

5. The method of claim 1, further comprising:
receiving information on a Timing Synchronization Function (TSF) of the target AP; and
synchronizing with the target AP based on the information on the TSF.

6. The method of claim 1, further comprising:
receiving information on at least one neighboring AP from a serving AP,
wherein the information on the at least one neighboring AP comprises at least one of beam information to be used when communicating with the neighboring AP, a key value authenticated with the neighboring AP, and an Association IDentifier (AID) value to be used in the neighboring AP.

7. A method of operating an Access Point (AP) in a wireless communication system, the method comprising:
transmitting information on at least one neighboring AP to a terminal for performing a handover; and
transmitting, to a target AP with which the terminal performs the handover, information required to allocate a resource to the terminal before the terminal accesses the target AP.

8. The method of claim 7, further comprising:
receiving resource allocation information for reporting the resource allocated to the terminal by the target AP before the terminal accesses the target AP; and
transmitting the resource allocation information to the terminal.

9. The method of claim 8, wherein the resource allocation information indicates that the resource is a resource allocated to the terminal by using a Media Access Control (MAC) address of the terminal and additional identification information defined for the handover.

10. The method of claim 8, wherein the resource allocation information comprises information on a Service Period (SP) allocated to the terminal.

11. The method of claim 7, wherein the information on the at least one neighboring AP comprises at least one of beam information to be used when communicating with the neighboring AP, a key value authenticated with the neighboring AP, and an Association IDentifier (AID) value to be used in the neighboring AP.

12. The method of claim 7, wherein the information on the terminal comprises at least one of a MAC address of the terminal, beam information to be used when the target AP performs signal transmission/reception with respect to the terminal, a key value to be used by the terminal in the target AP, an AID value to be used by the terminal in the target AP, and capability information of the terminal.

13. A method of operating an Access Point (AP) in a wireless communication system, the method comprising:
transmitting resource allocation information for reporting a resource allocated to a terminal which is accessing a different AP; and
receiving a signal for a registration from the terminal through a resource indicated by the resource allocation information.

14. The method of claim 13, wherein the resource allocation information indicates that the resource is a resource allocated to the terminal by using a Media Access Control (MAC) address of the terminal and additional identification information defined for the handover.

15. The method of claim 13, wherein the resource allocation information comprises information on a Service Period (SP) allocated to the terminal.

16. The method of claim 13, wherein the signal for the registration comprises at least one of a probe request, an authentication request, and an association request.

17. The method of claim 13, further comprising:
receiving information on the terminal from the different AP,
wherein the information on the terminal comprises at least one of a MAC address of the terminal, beam information to be used when the AP performs signal transmission/reception with respect to the terminal, a key value to be used by the terminal in the AP, an AID value to be used by the terminal in the AP, and capability information of the terminal.

18. A terminal apparatus in a wireless communication system, the apparatus comprising:
a receiver configured to receive resource allocation information for reporting a resource allocated by a target Access Point (AP) before accessing the target AP for a handover; and
a transmitter configured to transmit a signal for a registration to the target AP through a resource indicated by the resource allocation information.

19. The apparatus of claim 18, wherein the resource allocation information indicates that the resource is a resource allocated to the terminal by using a Media Access Control (MAC) address of the terminal and additional identification information defined for the handover.

20. The apparatus of claim 18, wherein the resource allocation information comprises information on a Service Period (SP) allocated to the terminal.

21. The apparatus of claim 18, wherein the signal for the registration comprises at least one of a probe request, an authentication request, and an association request.

22. The apparatus of claim 18, wherein the receiver receives information on a Timing Synchronization Function (TSF) of the target AP, and
wherein the receiver further comprises a controller configured to synchronize with the target AP by using information on the TSF.

23. The apparatus of claim 18,
wherein the receiver receives information on at least one neighboring AP from a serving AP, and
wherein the information on the at least one neighboring AP comprises at least one of beam information to be used when communicating with the neighboring AP, a key value authenticated with the neighboring AP, and an Association IDentifier (AID) value to be used in the neighboring AP.

24. The apparatus of claim 18, further comprising:
a controller configured to control the apparatus to perform a registration procedure with the target AP based on the resource.

25. An Access Point (AP) apparatus in a wireless communication system, the apparatus comprising:
a transmitter configured to transmit information on at least one neighboring AP to a terminal for performing a handover; and
a backhaul communication unit configured to transmit, to a target AP, for which the terminal performs the handover, information required to allocate a resource to the terminal before the terminal accesses the target AP.

26. The apparatus of claim 25,
wherein the backhaul communication unit receives resource allocation information for reporting the resource allocated to the terminal by the target AP before the terminal accesses the target AP, and
wherein the transmitter transmits the resource allocation information to the terminal.

27. The apparatus of claim 26, wherein the resource allocation information indicates that the resource is a resource allocated to the terminal by using a Media Access Control (MAC) address of the terminal and additional identification information defined for the handover.

28. The apparatus of claim 26, wherein the resource allocation information comprises information on a Service Period (SP) allocated to the terminal.

29. The apparatus of claim 25, wherein the information on the at least one neighboring AP comprises at least one of beam information to be used when communicating with the neighboring AP, a key value authenticated with the neighboring AP, and an Association IDentifier (AID) value to be used in the neighboring AP.

30. The apparatus of claim 25, wherein the information on the terminal comprises at least one of a MAC address of the terminal, beam information to be used when the target AP performs signal transmission/reception with respect to the terminal, a key value to be used by the terminal in the target AP, an AID value to be used by the terminal in the target AP, and capability information of the terminal.

31. An Access Point (AP) apparatus in a wireless communication system, the apparatus comprising
a transmitter configured to transmit resource allocation information for reporting a resource allocated to a terminal which has an access to a different AP; and
a receiver configured to receive a signal for a registration from the terminal through a resource indicated by the resource allocation information.

32. The apparatus of claim 31, wherein the resource allocation information indicates that the resource is a resource allocated to the terminal by using a Media Access Control (MAC) address of the terminal and additional identification information defined for the handover.

33. The apparatus of claim 31, wherein the resource allocation information comprises information on a Service Period (SP) allocated to the terminal.

34. The apparatus of claim 31, wherein the signal for the registration comprises at least one of a probe request, an authentication request, and an association request.

35. The apparatus of claim 30, further comprising:
a backhaul communication unit configured to receive information on the terminal from the different AP,
wherein the information on the terminal comprises at least one of a MAC address of the terminal, beam information to be used when the AP performs signal transmission/reception with respect to the terminal, a key value to be used by the terminal in the AP, an AID value to be used by the terminal in the AP, and capability information of the terminal.
